(19) United States
(12) Patent Application Publication
(10) Pub. No.: US 2010/0250372 A1
(43) Pub. Date: Sep. 30, 2010

(54) METHOD OF ELECTRONIC GIFTING AND YIELD MANAGEMENT

(76) Inventors: Matthew Anthony Smith, Paradise Valley, AZ (US); Nicholas Edwin Stewart, Fallbrook, CA (US)

Correspondence Address: Infinite IP LLC, 7632 E. Stetson Dr., Suite 203, Scottsdale, AZ, 85251, US

(21) Appl. No.: 12/412,698

(22) Filed: Mar. 27, 2009

(51) Int. Cl. G06Q 30/00; G06F 15/16; G06Q 20/00

(52) U.S. Cl. 705/14.68; 709/204; 705/26

(57) ABSTRACT

A method for facilitating electronic gifting transactions by a remote purchasing system and business yield management by a promotion configuring system. A customer user may remotely purchase a gift for a recipient, by selecting from available promotions through an interface in an electronic forum. The gift is available through electronic messaging to the recipient in real time or near real time to be redeemed at a designated business venue. A business user may customize promotions for a venue and make available promotions to customer users in real time or near real time. The business user may track, view, and manipulate statistical data related to the electronic gifting transactions in real time or near real time.

### FIELD OF INVENTION

The invention disclosed herein relates generally to methods of electronic gifting by remote purchasing means and business yield management by means to configure promotions.

### BACKGROUND

Businesses often rely on marketing to encourage potential customers to visit their particular business. These marketing activities may range on a spectrum from broad to narrow depending on which potential customers are targeted. On the broad end of the spectrum, marketing campaigns such as radio, newspaper or television advertisements broadcast to the public indiscriminately and cover a broad base. While this broad method of marketing provides some assurance that the most likely customers for the business are reached, the business also incurs the cost of broadcasting to people that are not interested in the product or service no matter the amount of advertising they are exposed to. In an effort to make the funds spent on marketing more effective many businesses move across the marketing spectrum to more narrow or targeted activities.

On the more narrow or targeted end of the spectrum, the business ideally only advertises among the most likely people to become potential customers. To achieve this level of efficiency in advertising the business usually needs access to information about the potential customers that is difficult to attain. The information of value pertaining to potential customers may include where the customers like to spend their time and money, if the customers have a preference for a certain product or service where the field may be filled with an abundance of competitors, or new products and services the customers may be inclined to try if an incentive or discount was offered. While this information could be attained by a business, it is often very labor intensive and costly. Existing methods requiring high costs and large amounts of labor and may include customer surveys, which usually require a team of people to construct the survey, administer the survey, aggregate the results and interpret the results.

Statistical tracking with traditional print coupons may provide some of the more general information desired by the business, but will often not provide the most valuable details and can require very costly systems that have to be integrated at the point of sale. Time, date and place of a coupon's redemption may be tracked, but the valuable information such as the identity of the redeemer is often unavailable or unreliable. A business may not be able to tell if the original recipient transferred the coupon to another person who became the end user. One example highlighting the value of the missing information would be in a scenario where the business knows that over a period of two weeks 10 coupons were redeemed at the same location. However, the business would not know the valuable information of whether the coupons were redeemed by 10 different people or by the same person 10 different times.

While this valuable information is valuable for targeting the most likely potential customers is difficult or costly for a business to obtain, this same information is typically known by the people that make up the potential customers' “social network”, such as friends, family, co-workers, teammates, or acquaintances of the potential customer. If the people who do know this information about the potential customer were working with the business, the business could increase the cost effectiveness of their advertising expenditures. Two fields where a business could potentially realize this benefit is in the fields of electronic gifting and electronic social networking.

Currently, electronic gifting models exist but suffer from numerous deficiencies. One such deficiency is that businesses often contain the structure to allow one person to remotely purchase a gift and have it sent to a recipient, but are not able to statistically track the gift through the whole process from purchase to receipt or redemption. The remote gifting transaction always has a sending party and a recipient party, but these identities are not always reliably tracked by current systems. Also, the time, date, and location of both the purchase or sending and the recipient or redemption of the gift are valuable data when tracked by current systems, but even more valuable when the data can be tied to specific identities of the parties involved in the transaction. Electronic gifting also currently exists for electronic social network forums but again suffers from deficiencies. Often members of the social network are gifting “virtual” or pretend gifts which do not provide any direct revenue or statistical information for the business without a sale, and do not create a customer presence at the physical or “brick and mortar” location of the business.

The current invention provides a solution to these problems through an electronic gifting and yield management method. The method provides means for a business to market in a targeted and cost effective manner through customized promotions. By setting up a customized promotion, a business allows participants to send the paperless, electronic promotion to other potential customers that participants identify through relationships such as, but not limited to friendship, family and work. The business receives the general benefits of: a potential sale; a customer presence at the business location; valuable real time or near real time statistical data regarding the sender, recipient and promotion redemption; the ability to create, edit or delete promotions in real time or near real time; and the ability to market on an electronic social network forum. Specifically, the business receives the benefit of marketing on an electronic forum where the marketing is created by the potential customers themselves in the act of one potential customer sending a gift to another potential customer. These benefits are achieved without the costs of significant integration of new equipment or software at the point of sale, or costs associated with the distribution of unsuccessful promotions.

### SUMMARY

A method for facilitating an electronic gifting transaction by remote purchasing means, and a method for business yield management by means to configure promotions. A customer user may remotely purchase a gift through an interface in an electronic forum containing registration information specific to a customer user. A customer user is allowed to select the recipient of the gift, such as but not limited to other customer users registered with the electronic forum, and a gift from available business venues and promotions. The gift is available through electronic messaging means to the recipient's electronic mobile device in real time or near real time to be redeemed at a designated business venue.

A business user may customize promotions for a venue and make available promotions to customer users in real time or near real time through the electronic gifting system. The subject matter, as well as the parameters, of the promotion are selected or defined by the business user. The parameters of the promotion may include, but are not limited to, the individual days of the week the promotion is available, the times of the day the promotion is available, the date the promotion will begin, the date the promotion will end, the amount of the discount, the number of promotions that will be available in a defined period of time, a specific geographic area, or a specific venue location. The business user satisfies the purchased gifts at the venue through verification of an electronic message presented by the recipient.

The business user may track, view, and manipulate statistical data related to the electronic gifting transactions in real time or near real time. The statistical data may include, but are not limited to number of promotions purchased/sent per venue; number of promotions purchased/sent per customer user; number of promotions redeemed at each venue; number of promotions redeemed per customer user; date and time of promotion redemption at each venue; date and time of promotion redemption for each customer user; promotion types redeemed at each venue; promotion types redeemed for each customer user; number of promotions available to be purchased/sent per venue; and number of unredeemed promotions for each customer user.

### BRIEF DESCRIPTION OF THE FIGURES

The object, features and advantages of the present invention will become more apparent by describing the preferred embodiments with reference to the accompanying figures, in which:

FIG. 1 is a flow diagram outlining an example of the steps and sub-steps for the method from the vantage point of a customer user.

FIG. 2 is a screen shot displaying an example embodiment of an interface to select a recipient.

FIG. 3 is a screen shot displaying an example embodiment of an interface to select a venue.

FIG. 4 is a screen shot displaying an example embodiment of an interface to select a gift from available promotions.

FIG. 5 is a screen shot displaying an example embodiment of an interface to purchase and send the gift.

FIG. 6 is a screen shot displaying an example embodiment of a posted message detailing user activity.

FIG. 7 is an illustration of an example embodiment of a gift notification electronic message received on an electronic mobile device.

FIG. 8 is an illustration of an example embodiment of a redeemable coupon electronic message received on an electronic mobile device.

FIG. 9 is a flow diagram outlining an example of the steps and sub-steps for the method from the vantage point of a business user.

FIG. 10 is a screen shot displaying an example embodiment of a login interface for an electronic gifting system.

FIG. 11 is a screen shot displaying an example embodiment of an interface for registering a business user contact person.

FIG. 12 is a screen shot displaying an example embodiment of an interface for registering a business user venue.

FIG. 13 is a screen shot displaying an example embodiment of an interface for selecting the subject matter for a promotion.

FIG. 14 is a screen shot displaying an example embodiment of an interface for selecting the parameters for a promotion.

FIG. 15 is a screen shot displaying an example embodiment of an interface for an overview of available statistics.

FIG. 16 is a screen shot displaying an example embodiment of an interface for an overview of promotions made available by the Business User.

FIG. 17 is a screen shot displaying an example embodiment of an interface for a detailed view of available statistics.

### DETAILED DESCRIPTION

1. Definitions

Electronic Forums—any forum implemented with electronic, computing or data processing devices which communicate over an electronic network such as, but not limited to, Local Area Network (LAN), Wide Area Network (WAN), Metropolitan Area Network (MAN), Personal Area Network (PAN), Virtual Private Network (VPN), Campus Area Network (CAN), Storage Area Network (SAN), world wide web (WWW), internet, intranet, extranet, telephone networks, etc.; and requires a registered user to provide login information to access the forum. The forums include, but are not limited to, social network sites (e.g. Myspace, Facebook, Friendster, Linkedin, etc.), websites, web pages, mobile phone applications, virtual worlds, online gaming, online dating, online communities, etc.

Electronic Gifting System—any system implemented with electronic, computing or data processing equipment and devices which communicate over an electronic network such as, but not limited to, Local Area Network (LAN), Wide Area Network (WAN), Metropolitan Area Network (MAN), Personal Area Network (PAN), Virtual Private Network (VPN), Campus Area Network (CAN), Storage Area Network (SAN), world wide web (WWW), internet, intranet, extranet, telephone networks, etc.; contains an electronic means of data storage such as, but not limited to, random access memory (RAM), read only memory (ROM), volatile memory, non-volatile memory, cache, flash memory, hard drives, hard disks, etc.; and facilitates remote purchasing transactions.

Electronic Mobile Device—any portable electronic device capable of computing, data storage, data processing or communication such as, but not limited to, cellular phones, personal digital assistants (PDA), laptop computers, hand held computers, etc.

Electronic Message—any means of electronically transmitting data for visual display such as, but not limited to, text messages, picture messages, Short Message Service (SMS), Multimedia Message Service (MMS), Enhanced Message Service (EMS), instant messages, electronic mail (email), etc.

Venue—the location of any business that provides a product, benefit or hosts an event such as, but not limited to, bars, lounges, night clubs, restaurants, retail stores, movie theatres, concert arenas, sports arenas, golf courses, fitness clubs, etc; or provides a service, such as but not limited to a business providing skill lessons (piano, dancing, etc.), a tax preparation business, a massage/health spa, a hair/beauty salon, etc. The location may be a physical location, such as but not limited to a street address, or a virtual location, such as but not limited to an address for a website, web page, online gaming environment, etc.

Real Time or Near Real Time—as near to instantaneous as possible and inhibited only be the inherent limitations in electronic hardware, software, and networks performing data processing.

Coupon—a certificate, voucher or token that entitles the redeemer to a discount or benefit related to a specified product, benefit or service as dictated by the promotion designed by the business responsible for satisfaction.

Recipient—a party that receives a coupon for redemption in an electronic gifting transaction.

Known Selection Means—any known means to choose, identify or select used with electronic, computing or data processing devices including, but not limited to: choosing, identifying or selecting a link, tab, menu, icon, check box, radio button, button, etc.; by utilizing a keypad, computer mouse, touch screen, touch pad, voice commands, etc.

Customer User—a user within the method that purchases, sends, receives or redeems a coupon or promotion.

Business User—a user within the method that creates a promotion and satisfies coupons presented at the associated venue.

2. Overview

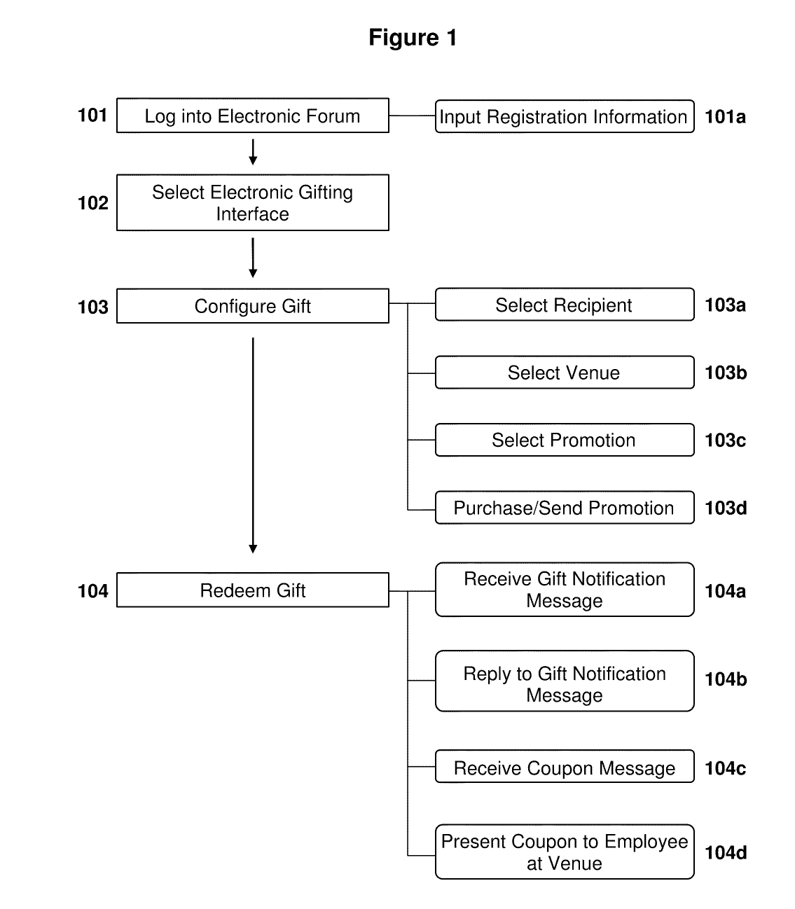

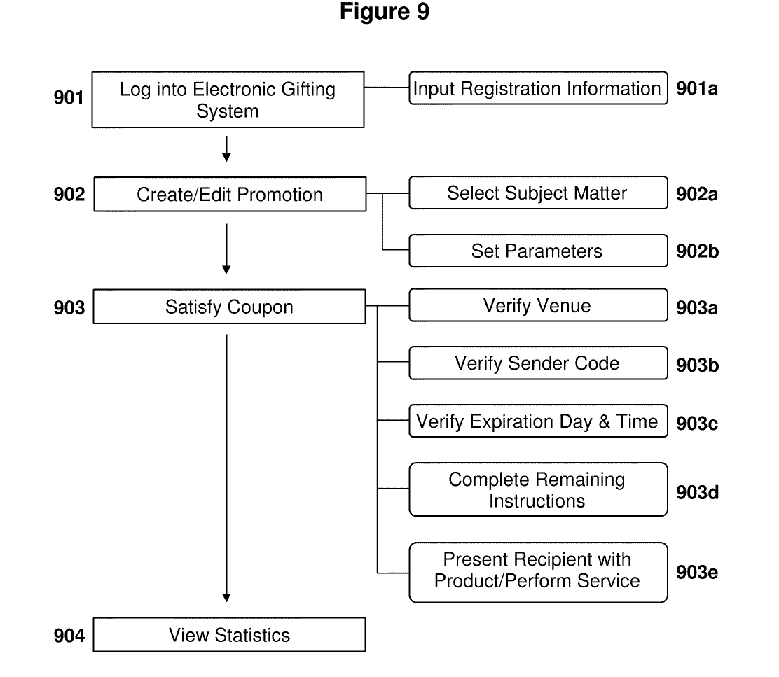

The preferred embodiment describes a method of remotely purchasing and gifting within the context of a promotion set up by a business. Within this method two different users are included and will be discussed separately for explanatory purposes only. The first users within the method are the customers. The customer users will include those parties that are senders/purchasers, recipients and redeemers of the coupon within the method. The second users within the method are the businesses that operate at the venues. The interaction within the method of the customer users will be discussed first (as illustrated in FIG. 1), followed by a discussion of the interaction within the method of the business user (as illustrated in FIG. 9).

3. Customer Users

FIG. 1 illustrates the first step 101 of the method for a customer user is to log into an electronic forum using an electronic, computing or data processing device. A login may include but is not limited to the customer user inputting a username, email address, ID number or password. The login provides the customer user access to the information that the customer user has registered with the electronic forum. The customer user will input registration information upon logging into the electronic forum the first time 101a and may edit this information in subsequent logins thereafter. The registered information may include, but is not limited to, name, street address, email address, phone number, and a list of contacts consisting of other customer users registered with the electronic forum. Some electronic forums may allow more information about a customer user to be registered in order to create a profile of the customer user. Such a profile may consist of information such as, but not limited to: preferences regarding food, beverages, music, movies, books, sports or entertainment; information on schools attended; employment information; personal interests; hobbies; birthday; etc.

Once the customer user is logged into the electronic forum the next step is for the customer user to select the electronic gifting interface 102 for the electronic gifting system. The electronic gifting system may be used with a plurality of electronic forums which may each have a different interface for implementing the electronic gifting system. The selection of the electronic gifting interface may occur by any known selection means. The electronic gifting interface may be displayed in any number of known means on an electronic, computing or data processing device, such as but not limited to a separate screen within the electronic forum, a separate window on the device interface, within a pop up window or menu on the device interface, etc. or a stand alone external website. With a stand alone external website, the website may include elements of both an electronic forum and the electronic gifting system or interface, and thus the step of selecting the electronic gifting interface within the electronic forum would include accessing the website and logging in.

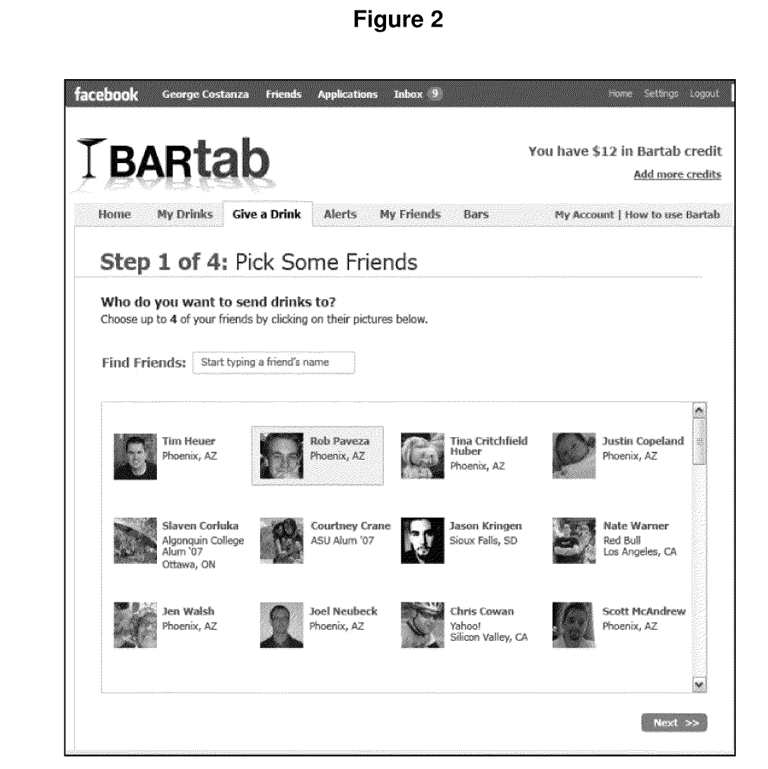

With the electronic gifting interface before the customer user, the customer user proceeds to the step of configuring a gift 103. The customer user configures a gift by first selecting a recipient for the electronic gift 103a. The customer user may choose themselves as the recipient or select a different person as the recipient. The recipient may be chosen by methods such as, but not limited to, selecting from the list of contacts comprising other customer users registered with the electronic forum, inputting a recipient's email address, inputting a recipient's telephone number, etc. The contacts may be presented as a list or in a graphical manner such as a representative picture, image, icon or other indicia. One example of a presentation of potential recipients is illustrated in FIG. 2. The customer user may also search for a contact by inputting the identifying information for a contact such as, but not limited to, name, username, email address, etc., to search a database of contacts. The selection of a recipient may occur by any known selection means.

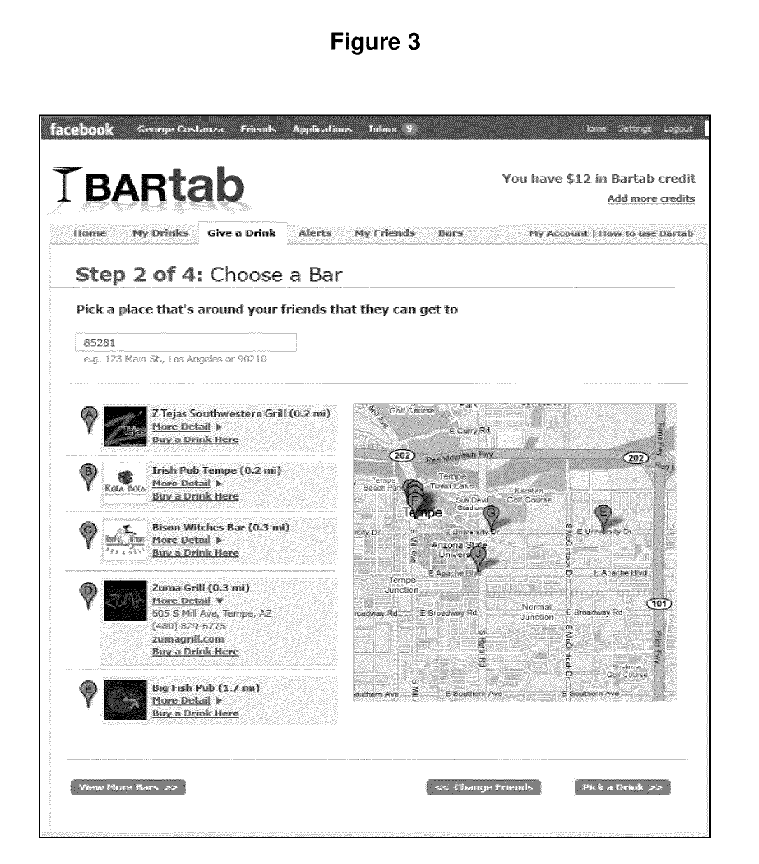

In the next step, the customer user selects a business venue 103b from the businesses that have registered to provide electronic gifting. The customer user may select a business venue from a list of participating business names or search for a participating business identified by attributes including, but not limited to, business name, geographic location, business type, recipient's favorites, etc. The customer user may input a business name, zip code, city, state to search a database of participating businesses or select from a list of predefined business categories. The search results for participating businesses may be presented as a list or by graphical means, such as but not limited to, a map with indicia showing the physical location of the business venue. Additional information related to the business venue is also available by selecting the appropriate indicia associated with the business venue. One example of a presentation of potential venues is illustrated in FIG. 3. The selection of the business venue may occur by any known selection means. In the alternative, there may also be only one business venue available. In this case the venue selection step would include making the selection of the only venue available and the process would continue as described with the available venue as the selected venue.

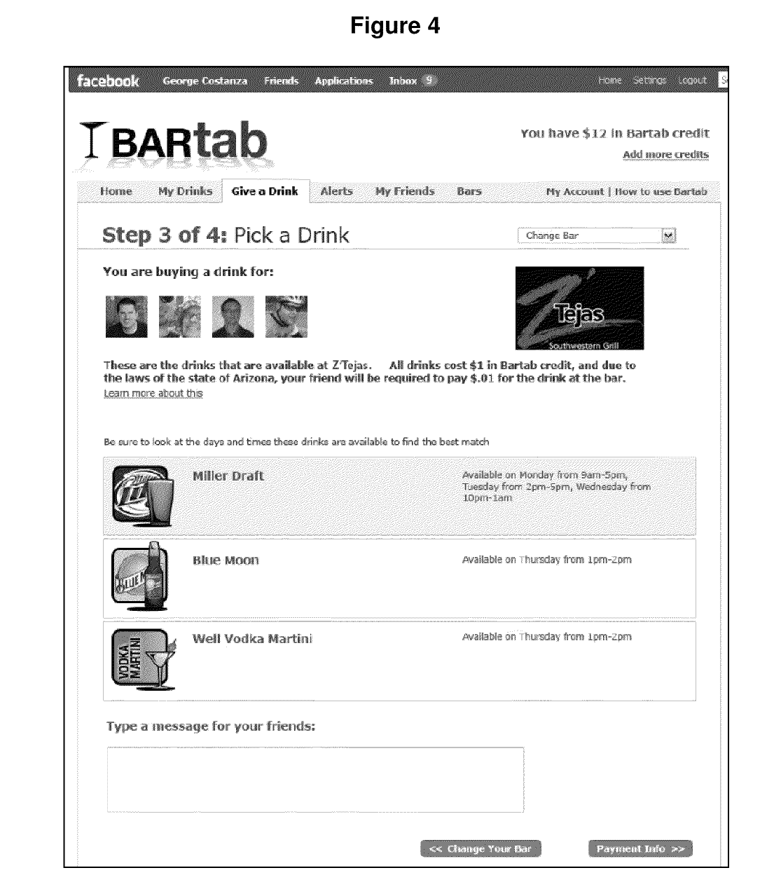

Following the selection of a business venue, the customer user continues to the step of selecting from the promotions currently available 103c at the business venue. The selected promotion will be the subject matter of the gift to the recipient, such as a product or service. The promotions available may vary by parameters such as, but not limited to, the type of benefit, amount of the discount, days available for redemption, times available for redemption, etc. One example of a presentation of available promotions is illustrated in FIG. 4. The selection of a promotion may occur by any known selection means. The customer user also has the option during this step to type a message to the recipient that will be delivered with the gift. In the alternative, there may also be only one promotion available. The single promotion would be selected and the process would continue as described with the available promotion as the selected promotion. While described above in one order, the steps required to configure a gift can achieve the same objective by occurring in any order, such as the customer user may select the venue first, the recipient second, and the promotion third, or any combination thereof.

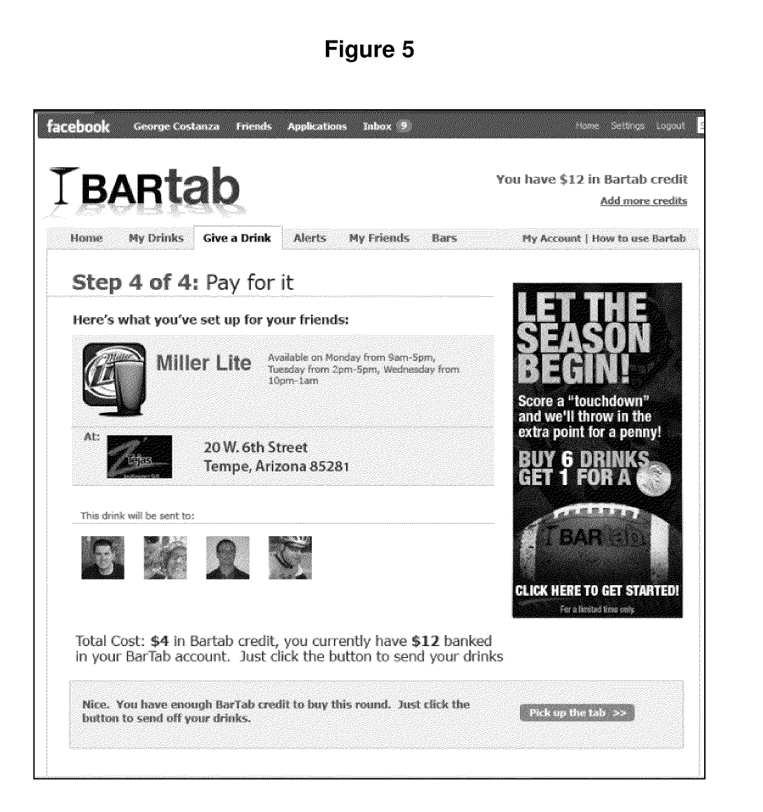

To finalize the electronic gift to the recipient the customer user completes the step of purchasing the selected promotion 103d. The customer user confirms the selections made in the prior steps and makes the selection to purchase and have the electronic gifting system send the gift to the recipient. One example of purchasing and sending a gift is illustrated in FIG. 5. The selection to purchase and send the gift may occur by any known selection means. Payment for the gift is then processed by known means such as, but not limited to, charging a credit card, deducting funds from a previously established monetary account, deducting funds from a previously established non-monetary rewards account, etc. With the payment complete the gift is sent to the recipient by the electronic gifting system in real time or near real time.

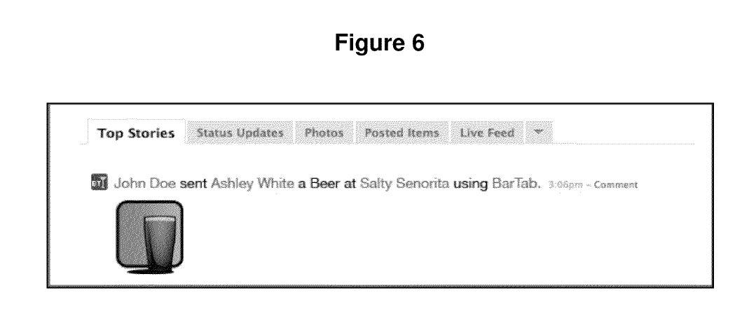

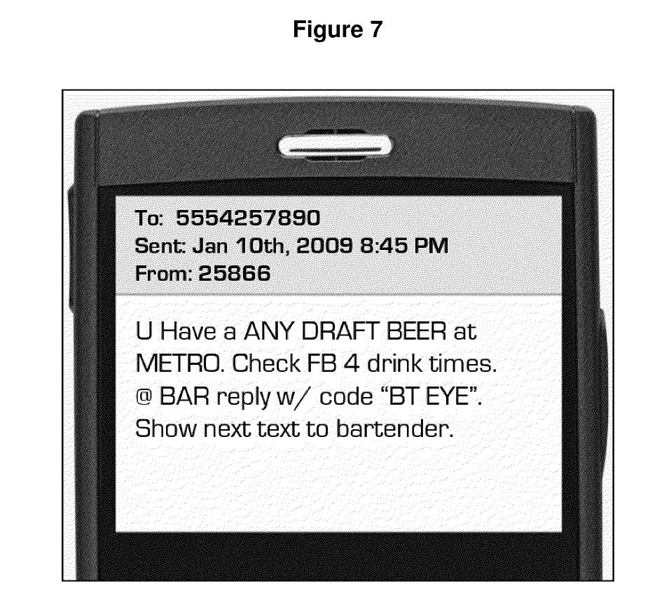

Next in the method are the sub-steps to redeem the gift 104, which begins with receipt of the gift by the recipient. The receipt of the gift by the recipient occurs in real time or near real time with the purchase of the gift. The recipient receives notification of the gift 104a through an electronic message from the electronic gifting system. One example of a gift notification electronic message is illustrated in FIG. 7. In the event that the electronic forum used to make the electronic gift is an electronic forum with user profiles and means to display user activity relating to the profile, a number of events will occur in real time or near real time. First, the recipient will receive an electronic message within their profile on the electronic forum indentifying the details of the gift received, such as the type of gift and business venue, and the user who sent the gift. Second, the identities of the sending user, receiving user, the type of gift and the business venue will appear in the location of the forum displaying user activity. One example of a message posting in a user activity location of an electronic forum is illustrated in FIG. 6.

When the recipient views the electronic message notifying the recipient of the gift, the recipient can have the gift notification sent by electronic message to an electronic mobile device registered with recipient. An additional option for electronic forums is the notification may go directly to the electronic mobile device of the recipient by electronic message in real time or near real time, and skip the steps of receiving the electronic message within the recipients profile on the electronic forum or posting the electronic gift information under a user activity notice.

Once the recipient receives an electronic message notification of the gift on the recipient's electronic mobile device from the electronic gifting system the recipient may proceed to the steps of redeeming the gift. The notification on the recipient's electronic mobile device, as illustrated in FIG. 7, will be an electronic message with information including, but not limited to, the source or sender of the electronic message as identified by a number or numeric code, the date and time the electronic message was sent, the name of the recipient, the details of the gift, the venue at which the gift may be redeemed, and an alphanumeric keyword for use in replying to the electronic message. The next step 104b to redeeming the gift is for the recipient to reply to the electronic message containing the gift notification. For the reply step in redeeming the gift, the recipient will reply to the message sent by the electronic gifting system, using the same electronic mobile device which received the gift notification electronic message, with an electronic message containing the alphanumeric keyword identified in the gift notification. As an alternative to receiving and replying to an electronic message, the recipient could also activate and receive their electronic message comprising a redeemable coupon by simply pressing a button on an electronic mobile device application.

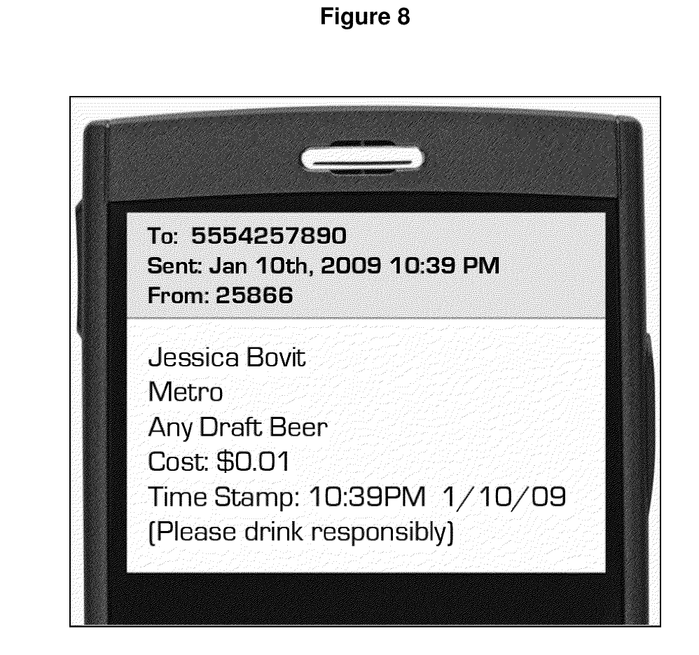

When the electronic gifting system receives a reply electronic message, the electronic gifting system verifies that the reply contains the correct alphanumeric keyword for redeeming the gift. When the alphanumeric keyword is verified, the electronic gifting system sends an electronic message to the recipient which comprises a coupon 104c capable of being redeemed. If the recipient activates and receives the electronic message comprising a redeemable coupon through an electronic mobile device application, the verification process with the electronic gifting system occurs in a manner similar to the method described above. One example of an electronic message comprising a redeemable coupon is illustrated in FIG. 8. The information included in the electronic message coupon may include, but is not limited to the source or sender of the electronic message as identified by a number or numeric code, the date and time the electronic message was sent, the name of the recipient, the details of the gift, the venue at which the gift may be redeemed, instructions on how to redeem the coupon, the date and time at which the coupon expires, branding of the venue; and a picture of the gift to be redeemed.

The final step to redeem the gift comprises the recipient presenting an employee at the business venue with the recipient's electronic mobile device visually displaying the coupon 104d. The employee verifies that the subject matter and validity of the coupon, and then completes the transaction with the recipient. Completing the transaction may involve presenting the recipient with a product or benefit, providing a service, or requesting the remaining balance of the transaction not covered by the coupon before presenting a product, benefit or providing a service.

4. Business Users

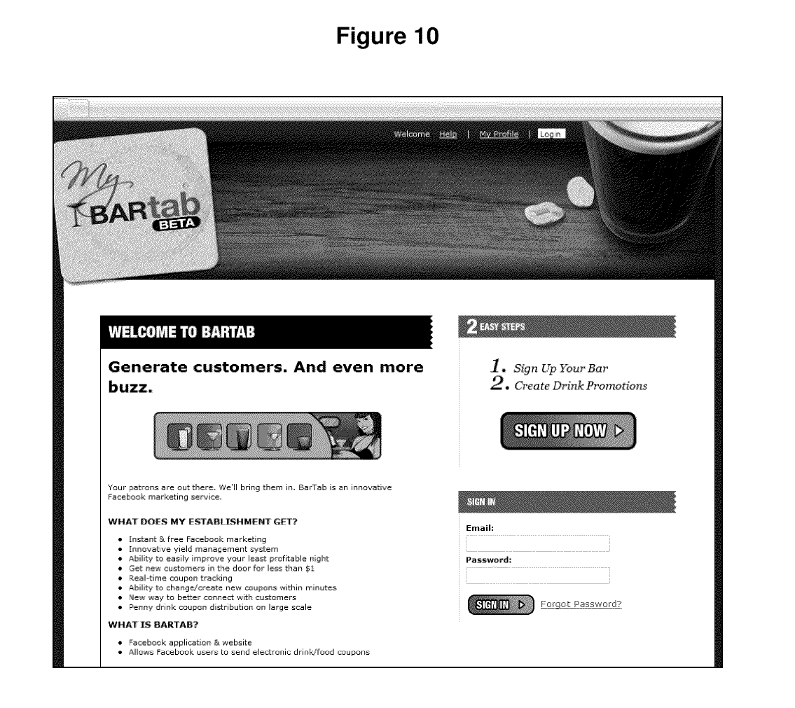

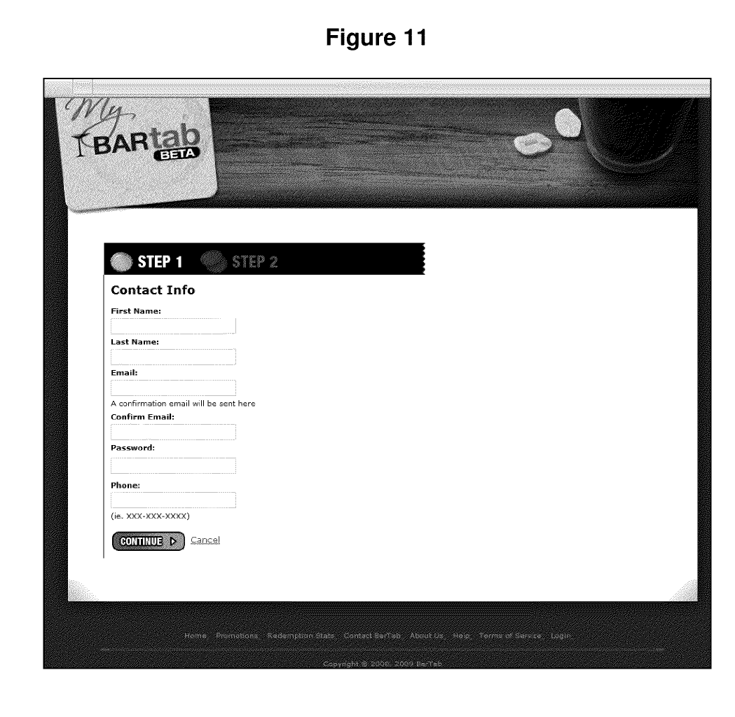

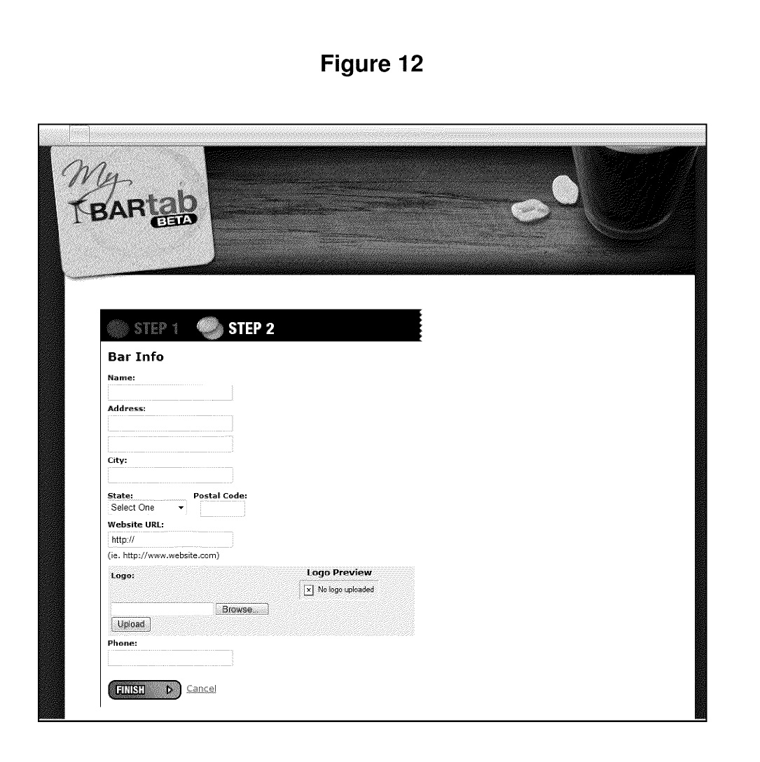

The first step of the method for a business user, as illustrated in FIG. 9, is to log into the electronic forum for the electronic gifting system 901 using an electronic, computing or data processing device. A login may include, but is not limited to, the business user inputting a username, email address, ID number or password. The login provides the business user access to the information that the business user has registered with the electronic forum and electronic gifting system. One example of an electronic forum interface for logging into the electronic gifting system is illustrated in FIG. 10. The business user will input the registration information for the business upon logging in the first time 901a and may edit this information in subsequent logins thereafter. Examples of an electronic forum interface for inputting business user registration information are illustrated in FIGS. 11-12. The registered information includes, but is not limited to, contact information for the business user (e.g. name, email address, phone number, etc.), business name, business website address, street address of venue, phone number of venue, and business logo in an electronic image format.

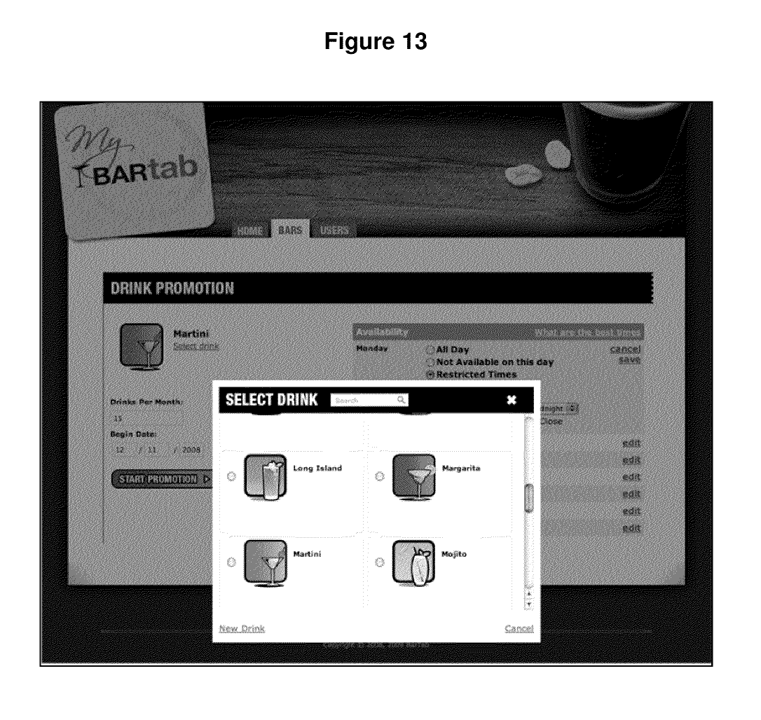

Once the business is registered with the electronic gifting system the business may create a promotion 902. The promotions are customizable by the business user by navigating through a series of steps. The first step in creating a promotion is to select the subject matter for the promotion 902a, such as a product, benefit or service. The subject matter may be selected from a list, menu or database of predefined products and services, or the business user may define the product or service themselves. One example of an interface for selecting the subject matter for a promotion is illustrated in FIG. 13. The selection of the subject matter may occur by any known selection means.

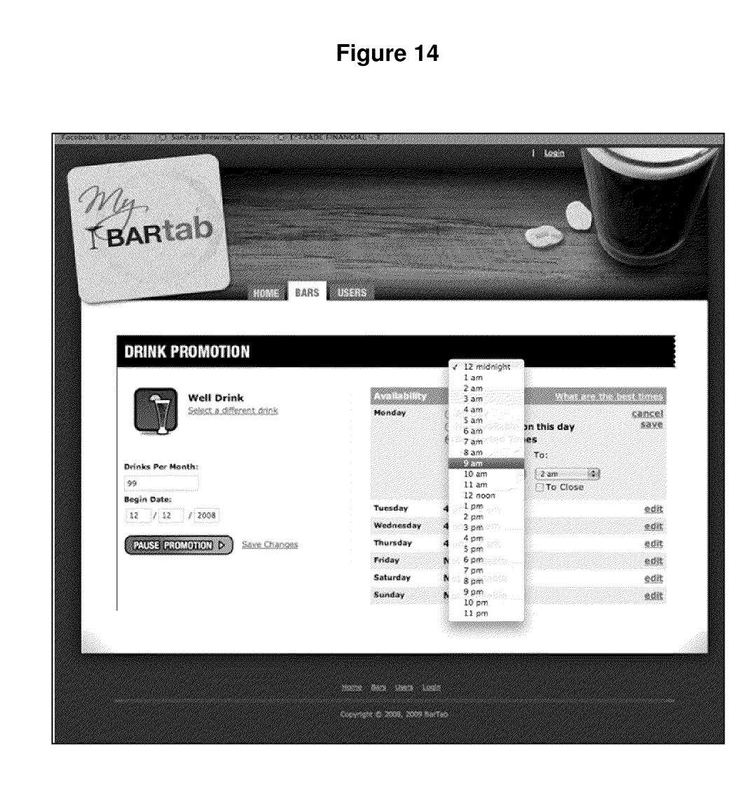

The second step in creating a promotion is to define the parameters of the promotion 902b. The parameters of a promotion include, but are not limited to, the individual days of the week the promotion is available, the times of the day the promotion is available, the date the promotion will begin, the date the promotion will end, the amount of the discount, the number of promotions that will be available in a defined period of time, geographic area promotion is offered, venue locations promotion is offered, etc. The parameters for a promotion may be selected from a predefined menu of parameters by known selection means, or the business user may define the parameters themselves and manually input parameters, or a combination of the two methods. One example of an interface for setting or defining the parameters for a promotion is illustrated in FIG. 14. While described above in one order, the steps required to create or edit a promotion can occur in any order. In the alternative, the business user may select the parameters first, and the subject matter second; select some parameters first, select the subject matter second, and select additional parameters third; or any combination thereof.

Once the parameters are set by the business user the promotion becomes available to the customer user through the electronic gifting interface in real time or near real time. The business user may also update promotions by editing the subject matter or parameters of an existing promotion or delete an existing promotion when logged into the electronic gifting system. Any updates on promotions performed by the business user will also be reflected on the electronic gifting interface for the customer user in real time or near real time. The ability of the business owner to choose the subject matter of the promotions and parameters of the promotions allow the marketing solution to constantly adjust to the changing needs of the business.

The next step of the method for the business user is to satisfy a coupon at the business venue 903. When a recipient of an electronic gift presents the electronic mobile device displaying an electronic message coupon at the venue (as illustrated in FIG. 8), an employee of the business must complete several tasks, in any order. All of the following tasks may be performed by the employee at the venue without the implementation of additional hardware, software, or equipment at the point of sale. First, the employee must verify that the venue listed in the coupon is the correct venue 903a. Second, the employee must verify that the number or numeric code identifying the source or sender of the coupon is the number or numeric code associated with the electronic gifting system 903b. Third, the employee must verify the coupon is not past the expiration date and time listed in the coupon 903c. Fourth, the employee must complete any remaining instructions for redeeming the coupon listed on the coupon 903d, such as, but not limited to, requesting the remaining balance of the transaction not covered by the coupon. Fifth, the employee then presents the recipient with the product, benefit or performs the service identified in the coupon 903e, thus completing the transaction. Additional steps such as tracking the promotion through the point of sale system by adding a “promotional sale” button to the point of sale system is another relatively unintrusive option the venue may implement.

While the embodiment described above has depicted an electronic gifting transaction and promotion in a setting involving a venue with a physical or street address location, one of ordinary skill in the art would appreciate that the invention can be implemented in a variety of venue locations. Other venue locations capable of implementing the invention include virtual locations such as, but not limited to, websites, web pages, online gaming environments, etc.

Once the business user has created a promotion which has resulted in the redemption of gifts, the business user may proceed to the next step of viewing statistics on the promotions 904. The electronic gifting system tracks statistics related to every aspect of the electronic gifting transactions, from the time of the initial purchase/sending of the gift through the time of the transmission of the redeemable coupon to the recipient's mobile electronic device by electronic message. The statistics tracked by the electronic gifting system include, but are not limited to: number of promotions purchased/sent per venue; number of promotions purchased/sent per customer user; number of promotions redeemed at each venue; number of promotions redeemed per customer user; date and time of promotion redemption at each venue; date and time of promotion redemption for each customer user; promotion types redeemed at each venue; promotion types redeemed for each customer user; number of promotions available to be purchased/sent per venue; and number of unredeemed promotions for each customer user. All of the data comprising statistics regarding the electronic gifting transactions are tracked and stored with the electronic gifting system in real time or near real time.

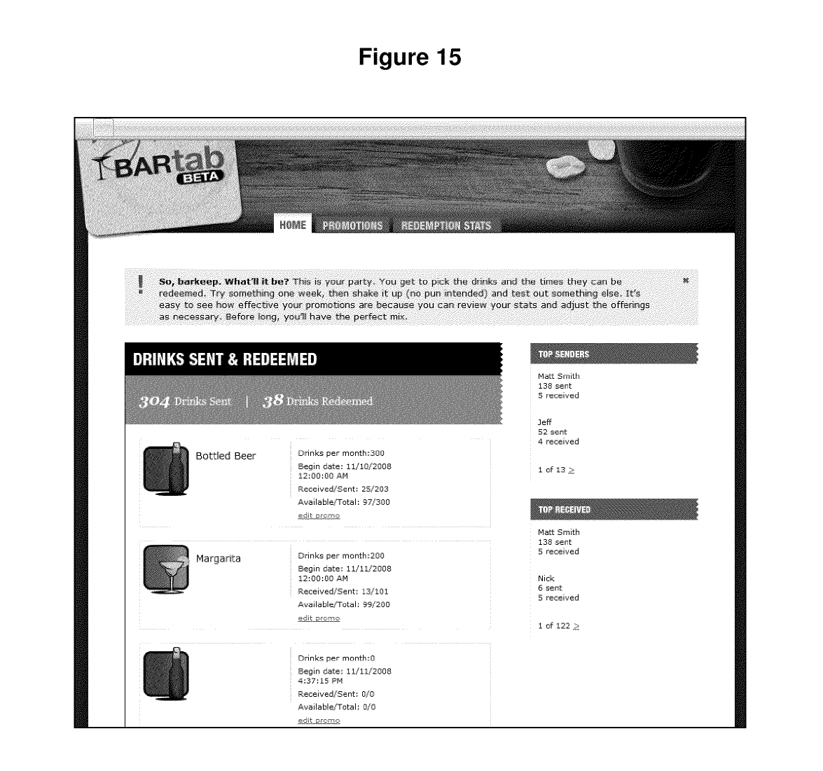

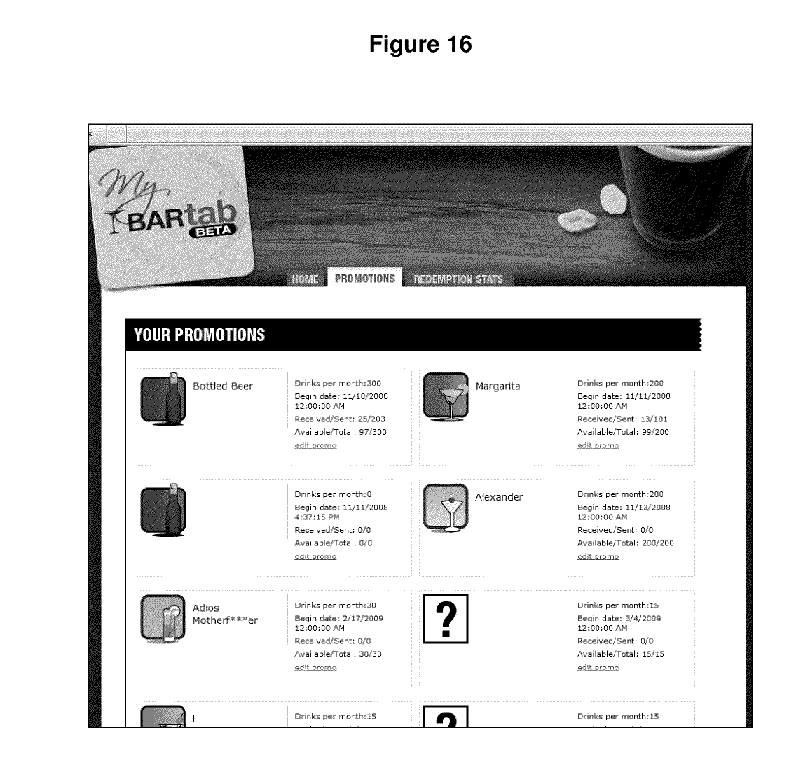

The electronic gifting system may make all of the statistics tracked available to a business user or only selected statistics available to a business user. Additional tracking capabilities may be available to the business user through full integration between the electronic gift system and the venue's point of sale system. The statistics available to a business user for viewing are updated in real time or near real time. The business user may view the statistics in a variety of formats. One format may be an overview or “quick” type format that gives the basic information on each of the promotions currently available for the business user. Examples of the overview or “quick” format for statistical presentation are illustrated in FIGS. 15-16. The overview or “quick” format may include, but is not limited to, the product, benefit or service of the promotion, the number of products, benefits or services available for the defined time period, the date and time the promotion began, the number of promotions purchased/sent, the number of promotions redeemed, and the number of promotions left that are available to be purchased/sent.

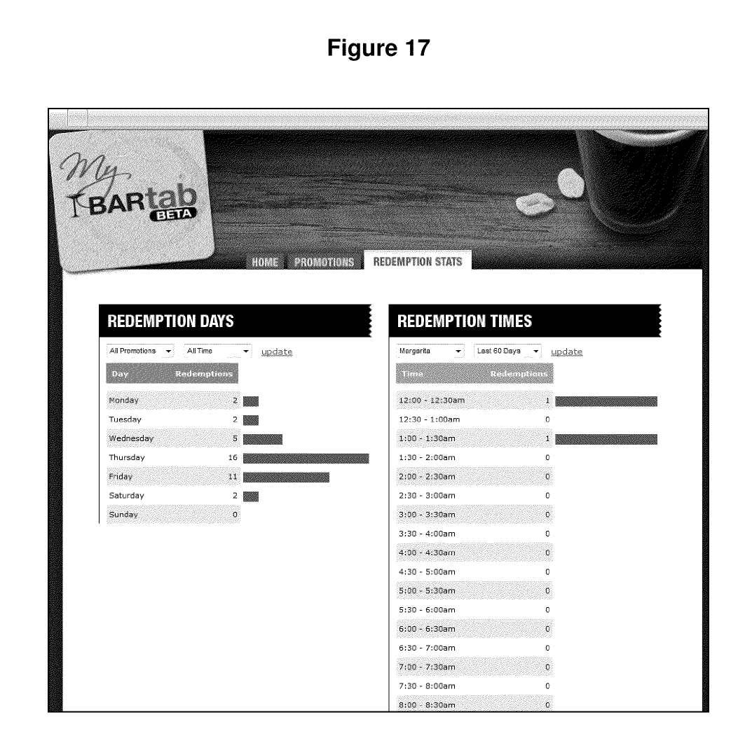

Another format for viewing the statistics is a more detailed and adjustable format. In the detailed format the business user is given the ability to manipulate the available statistical data for marketing analysis. One example of the detailed and adjustable format for statistical presentation is illustrated in FIG. 17. One option given is the business user may view the statistics cumulatively for all the promotions the business user has made available, individually for a single promotion the business user has made available, or a selected number of the promotions the business user has made available. The business user also has the option of viewing the statistics for the whole time the promotion has been running or for a shorter time period, such as the last week, last 30 days, last 60 days, or a custom date range defined by the business user. The statistics viewed in the manipulated formats may be the number of promotions purchased/sent, redeemed or both. The selection of the options to manipulate the statistical data may occur by any known selection means. The detailed statistics may also be presented in a variety of configurations such as, but not limited to, bar graphs, pie graphs, line graphs, charts, histograms, numeric lists, database entries, spreadsheets, colors, etc.

The statistical tracking provided by the electronic gifting system allows valuable marketing analysis, such as: who is sending each promotion, who is redeeming each promotion, at what time are the promotions redeemed, at what location are the promotions redeemed, and how many promotions are being sent but are not redeemed. With this marketing analysis the business user can make cost effective decisions on the creation of additional promotions, editing existing promotions or eliminating promotions in real time or near real time.

Although specific embodiments of the present invention have been illustrated and described herein, it will be appreciated by those of ordinary skill in the art that any arrangement which is calculated to achieve the same purpose may be substituted for the specific embodiments shown. In addition, although the above invention is demonstrated as a software based implementation, the invention could be implemented as software, hardware, or any combination foreseeable to one of ordinary skill in the art. This application is intended to cover any adaptations or variations within the spirit of the invention.

What is claimed is:

1) A method of conducting remote purchase transactions utilizing mobile electronic devices and data processing devices, the method comprising the steps of:
a) Logging into an electronic forum as a customer user;
b) Selecting an electronic gifting interface;
c) Configuring a gift; and
d) Redeeming the gift.

2) The method of claim 1, wherein said step of logging into an electronic forum further comprises the steps of:
a) Inputting registration information specific to a customer user; and
b) Storing said registration information specific to a customer user in an electronic memory.

3) The method of claim 2, wherein said registration information includes at least one from the group consisting of name, street address, email address, phone number, and a list of contacts consisting of other customer users registered with the electronic forum.

4) The method of claim 3, further comprising wherein said registration information specific to a customer user is accessed in an electronic memory of said electronic forum when the customer user logs into the electronic forum.

5) The method of claim 1, wherein said step of configuring a gift further comprises the following steps, in any order:
a) Selecting a recipient for the gift;
b) Selecting a venue;
c) Selecting a promotion from promotions available at a selected venue; and
d) Sending the gift to the recipient through electronic messaging.

6) The method of claim 5, wherein said recipient is selected by at least one from the group consisting of: a list of contacts comprising other customer users registered with the electronic forum, an email address and a telephone number.

7) The method of claim 5, wherein said venue is selected from a plurality of venues displayed in a graphical format.

8) The method claim 5, wherein said steps are executed in real time or near real time.

9) The method of claim 1, wherein said step of redeeming the gift further comprises the following steps:
a) Receiving a gift notification electronic message;
b) Replying to the gift notification electronic message with an electronic message;
c) Receiving a coupon electronic message; and
d) Presenting the coupon electronic message to an employee at the venue.

10) The method of claim 9, wherein receiving and replying of electronic messages is conducted on an electronic mobile device.

11) The method of claim 9, wherein a gift notification electronic message is received by the recipient through the electronic forum.

12) The method of claim 11, further comprising wherein a gift notification electronic message is posted in a location of the electronic forum which displays user activity.

13) The method of claim 9, wherein said steps are executed in real time or near real time.

14) The method of claim 9, wherein said coupon electronic message includes information indicating at least one from the group consisting of a sender code, venue, expiration day, expiration time, redemption instructions, branding of the venue, picture of the gift, and gift description.

15) A method of facilitating remote purchase transactions utilizing mobile electronic devices and data processing devices, comprising the following steps, in any order:
a) Logging into an electronic gifting system as a business user;
b) Creating or editing a promotion;
c) Satisfying a presented coupon;
d) Tracking statistical data related to electronic gift transactions; and
e) Viewing statistical data related to the electronic gift transactions.

16) The method of claim 15, wherein said step of logging into an electronic gifting system further comprises the following steps of:
a) Inputting registration information specific to a business user; and
b) Storing registration information specific to a business user in an electronic memory.

17) The method of claim 16, wherein said registration information includes at least one from the group consisting of name, street address, email address, and phone number.

18) The method of claim 16, further comprising wherein said registration information specific to a business user is accessed in said electronic memory when the business user logs into the electronic gifting system.

19) The method of claim 15, wherein said step of creating or editing a promotion further comprises the following steps, in any order:
a) Selecting a subject matter; and
b) Setting parameters for the promotion.

20) The method of claim 19, wherein said steps are executed in real time or near real time.

21) The method of claim 19, wherein said parameters include at least one from the group consisting of individual days of a week the promotion is available, times of a day the promotion is available, date the promotion will begin, the date the promotion will end, the amount of a discount, number of promotions that will be available in a defined period of time, specific geographic areas, and specific venues.

22) The method of claim 15, wherein said step of satisfying a presented coupon further comprises the following steps, in any order:
a) Verifying a venue identified in a coupon;
b) Verifying a sender code identified in the coupon;
c) Verifying an expiration day and time identified in the coupon; and
d) Completing remaining instructions identified in the coupon.

23) The method of claim 15, wherein tracking and viewing statistical data occurs in real time or near real time.

24) The method of claim 15, wherein statistics include at least one from the group consisting of number of promotions sent per venue, number of promotions sent per customer user, number of promotions redeemed at each venue, number of promotions redeemed per customer user, date and time of promotion redemption at each venue, date and time of promotions redemption for each customer user, promotion types redeemed at each venue, promotion types redeemed for each customer user, number of promotions available to be sent per venue, and number of unredeemed promotions for each customer user.

25) The method of claim 15, wherein statistical data may be viewed in a plurality of formats.

26) The method of claim 25, wherein said formats include at least one from the group consisting of bar graphs, pie graphs, line graphs, charts, histograms, numeric lists, database entries, spreadsheets and colors.

27) The method of claim 26, wherein said formats further include a format defined by the business user.

28) A method of conducting remote purchase transactions utilizing mobile electronic devices and data processing devices, the method comprising the steps of:
a) Receiving a gift notification electronic message;
b) Replying to the gift notification electronic message with an electronic message;
c) Receiving a coupon electronic message; and
d) Presenting the coupon electronic message to an employee at a venue.

29) The method of claim 28, wherein receiving and replying of electronic messages is conducted on an electronic mobile device.

30) The method of claim 28, wherein a gift notification electronic message is received by the recipient through an electronic forum.

31) The method of claim 30, further comprising wherein a gift notification electronic message is posted in a location of an electronic forum which displays user activity.

32) The method of claim 28, wherein said steps are executed in real time or near real time.

33) The method of claim 28, wherein said coupon electronic message includes information indicating at least one from the group consisting of a sender code, venue, expiration day, expiration time, redemption instructions, branding of the venue, picture of the gift, and gift description.

34) The method of claim 28, further comprising satisfying said coupon by said employee.

35) The method of claim 34, wherein said step of satisfying a presented coupon further comprises the following steps, in any order:
a) Verifying a venue identified in a coupon;
b) Verifying a sender code identified in the coupon;
c) Verifying an expiration day and time identified in the coupon; and
d) Completing remaining instructions identified in the coupon.
